(19) United States
(12) Patent Application Publication
(10) Pub. No.: US 2026/0355811 A1
(43) Pub. Date: Nov. 12, 2026

(54) Rivet And Method For Producing A Rivet Connection

(71) Applicant: Newfrey LLC, New Britain, CT (US)

(72) Inventors: Paul BARTIG, Giessen (DE); Maximilian STOCK, Giessen (DE); Matthias WISSLING, Giessen (DE)

(73) Assignee: Newfrey LLC, New Britain, CT (US)

(21) Appl. No.: 19/654,796

(22) Filed: Apr. 22, 2026

Related U.S. Application Data
(63) Continuation of application No. PCT/EP2024/079141, filed on Oct. 16, 2024.

(30) Foreign Application Priority Data
Oct. 23, 2023 (EP) 23205312.4

(51) Int. Cl. B21J 15/02; F16B 19/04

(52) U.S. Cl. CPC B21J 15/025; F16B 19/04; F16B 2019/045

(57) ABSTRACT

A self-piercing rivet for a riveted connection and a method for joining components by means of the self-piercing rivet are described herein. The self-piercing rivet includes a head with a top surface, a shaft longitudinally extending along a longitudinal axis, and a transition portion between the shaft and the head. The rivet is integrally made from a metal material and includes a coating adapted to prevent corrosion of the rivet. At least one projection is arranged on the top surface of the head.

### CROSS-REFERENCE TO RELATED APPLICATIONS

This application is a bypass continuation of International Application No. PCT/EP2024/079141, filed on Oct. 16, 2024, which claims the benefit of European Application No. 23205312.4, filed on Oct. 23, 2023. The entire disclosure of each of the above applications is incorporated herein by reference.

### FIELD

The present disclosure relates to a self-piercing rivet, and a method for producing a punch rivet connection.

### BACKGROUND

In the field of fastening technology, it is known to make joints using rivets. Especially in the field of automotive engineering, self-piercing riveting methods using a self-piercing rivet have been well-established for years, particularly in body manufacture.

In high-volume production, it is preferred to move the fastening tools adapted to set the rivet within a workpiece arrangement by means of a programmable handling device, such as a robot. In this case, it is likewise preferred for the rivets to be fed to a fastening tool attached to a robot arm. To this end, it is known to connect the fastening tool to a feeding device and to use a magazine arrangement for accommodating a plurality of rivets. One rivet of the plurality of rivets from the magazine arrangement is moved to the fastening tool in order to be punched within a workpiece arrangement.

Usually, the workpiece arrangement comprises an upper component and a lower component to be fastened. The upper and lower components are clamped and the self-piercing rivet held by the fastening tool is punched into the workpiece arrangement. A shaft of the self-piercing rivet pierces and penetrates the upper component. When the shaft of the self-piercing rivet penetrating the upper component enters the lower component and the lower surface of the lower component comes into contact with the bottom of a die, the bottom of the die cavity pushes back the lower component. As a result, a hollow shaft of the self-piercing rivet receives a reaction force from the lower component and opens in a ring shape in the lower component without fully penetrating the lower component. A mechanical interlock is formed by opening the shaft of the self-piercing rivet, and the upper component and the lower component are mechanically fastened.

The number of components to be fastened may be two, three or more. Eventually, the rivet may be fastened in only one component. For example, in the case of three components, at least the uppermost component is fully penetrated, and the lowermost component is not fully penetrated. In the production of automobiles, an adhesive is often applied between the components to be fastened in order to improve the performance with regard to load bearing capacity, crash stability, improved corrosion resistance, and Noise, Vibration, Harshness (NVH).

Although self-piercing rivets are well-known and widely used, there is a constant need to improve such fasteners in order to provide reliable, easy to use and to manufacture rivets.

Document EP2470799A1 for instance discloses a punch rivet adapted to be set in a workpiece arrangement of at least two workpieces.

Such rivets are generally coated to provide a corrosion protection and anti-friction performances.

Document DE 10 2014 000 623 B4 discloses a self-piercing rivet which has a corrosion protection layer which is covered by a top layer which allows one to adjust setting characteristics as friction and material flow.

US2007196632 discloses an anti-friction coating adapted for fasteners (and notably rivets) with a metal or alloy layer, over which a conversion coating layer is formed and a composite coating layer overlaying the conversion coating layer. The composite coating layer includes one or more lubricants.

However, there is still a need to improve the current fasteners and provide a rivet which ensures reliable setting behavior during the riveting process, while reducing the coefficient of friction, and reducing the dust in the setting tools and equipment. The rivet also needs to be easily coated in bulk to be quickly manufactured in an automated process.

### SUMMARY

Accordingly, the present disclosure provides a self-piercing rivet and a method for joining components by means of a rivet. More particularly, the self-piercing rivet comprises a head with a top surface, a shaft longitudinally extending along a longitudinal axis and a transition portion between the shaft and the head. The self-piercing rivet is integrally made from a metal material and comprises a three-layer coating adapted to prevent corrosion of the self-piercing rivet. At least one projection is arranged on the top surface of the head. The presence of the at least one projection on the top surface prevents adhesion during the coating, thus allowing the self-piercing rivets to be easily transported and used in an automated system without impacting the rivet joint performances. The coating improves the friction coefficient and the resistance to corrosion. No additional treatment on top is needed. The at least one projection reduces the contact area (and therefore the surface contact) tremendously between two top surfaces of two different self-piercing rivets when they face each other during the coating or the transport, for instance. The presence of the projection does not interfere with the setting process and parameters. More particularly, the projection may no longer be visible after the setting step. Thus, such a self-piercing rivet may notably be easily and completely coated in bulk, without the risk of having completely or partially uncoated surfaces or damages to the coating due to a sticking aspect of the self-piercing rivets during the coating. Indeed, for instance during a coating in bulk, if the self-piercing rivet sticks together, there is a risk that no complete coating is provided to the stuck surfaces and/or a risk of damaging the coating when isolating the self-piercing rivets from each other. The presence of the projection eliminates or mitigates this risk. Self-piercing rivets can easily be bulk-coated in large numbers in a single charge, making manufacture less time-consuming and less costly.

In an embodiment, the outer circumference of the shaft and the head top surface are coated with the three-layer coating. For instance, in case of a hollow or semi-hollow shaft, there is no need to coat the internal surface of the shaft. Besides, the friction coefficient is of particular relevance in the area of the shaft of the self-piercing rivet, and the head top surface needs to be coated in order to provide the necessary corrosion resistance.

In an embodiment, the three-layer coating comprises an electroplated coating layer, a passivation layer and a top coat layer. The zinc nickel layer is an anti-corrosion layer and the top coat layer reduces wear of friction.

In an embodiment, the electroplated coating layer is a zinc nickel layer. In an embodiment, the top coat layer is free of zinc and is applied over a water-soluble suspension.

In an embodiment, the passivation layer forms a non-metallic protection layer. For example, the passivation layer forms a nickel-free inorganic conversion layer. This will change the electrochemical corrosion potential of the coating system.

In an embodiment, the zinc nickel layer comprises a nickel content between 8 and 20 percent (%), preferably 12% to 16%. This nickel content provides a good compromise between cost and corrosion resistance.

In an embodiment, the head has a planar head upper side which defines the top surface and a head diameter DH, and wherein one projection is centered on the top surface of the head. The centered projection can be easily manufactured and does not increase the manufacturing time or complexity. In an embodiment, one projection extends on the entire top surface. In an embodiment, a plurality of projections is provided and the projections are evenly distributed over the top surface. Thus, no tilting of the self-piercing rivet during the setting occurs.

In an embodiment, the projection has a projection height Hp, the self-piercing rivet has a rivet height Ht between a rivet foot end and the top surface, and the projection height is between 1/500 and 1/50 of the rivet head diameter. Such range allows the projection to indeed have an impact on the rivet adhesion (or sticking effect) without influencing the self-piercing rivet performances during the setting.

In an embodiment, the projection has a conical, pyramidal, semi-spherical shape.

For instance, one projection is provided and the projection has a base defined by a portion of the top surface, and the base of the projection comprises a projection diameter between 1/2 and 1/10 of a head diameter. In an alternative embodiment, several projections are provided, and the projections all have a base defined by a portion of the top surface, each base comprises a projection diameter of less than 1/3 of the head diameter.

In an embodiment, the shaft is a hollow or semi-hollow shaft open at a first end and having a shaft internal diameter and a shaft external diameter, and the shaft comprises at the first end an annular cutting edge defining a cutting-edge diameter smaller than the shaft external diameter, and the shaft internal diameter merges with the annular cutting edge via a cutting-edge radius. This geometry allows good joining performances, notably for high-strength materials.

In an embodiment, the annular cutting-edge merges with the shaft external diameter via a shaft outer chamfer which is oriented at a chamfer angle.

In an embodiment, wherein the chamfer angle is of less than 45° in relation to a radial plane.

In an embodiment, the top coat layer is an organic coating, particularly an organic coating containing aluminum. In an embodiment, the top coat layer is a friction control coating layer and has a friction coefficient in a range from 0.01 to 0.19, particularly in a range from 0.08 to 0.18, and preferably in a range from 0.12 to 0.18 or in range from 0.08 to 0.13.

In an embodiment, the third coating layer is applied via a dip-spin process. The at least one projection prevents the rivets from sticking during the dip-spin process.

The present disclosure is also directed to a method for joining components by means of a self-piercing rivet which is deformed during the joining process. In an embodiment, the projection is visible before the setting step, and after the setting step, the top surface is sensibly planar. The projection is plastically deformed during the setting step.

### BRIEF DESCRIPTION OF THE DRAWINGS

The present disclosure will be better understood from the reading of the following description, given by way of example only and with reference to the accompanying drawings, of which:

FIG. 1 shows a perspective view of the self-piercing rivet according to the present disclosure;

FIG. 2 shows a side view of the self-piercing rivet of FIG. 1;

FIG. 3 shows the detail III of FIG. 2; and

FIG. 4 schematically shows a top surface of a self-piercing rivet with a plurality of projections according to a second embodiment.

### DETAILED DESCRIPTION

The embodiments of the disclosure will be best understood by reference to the drawings, wherein the same reference signs designate identical or similar elements. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure.

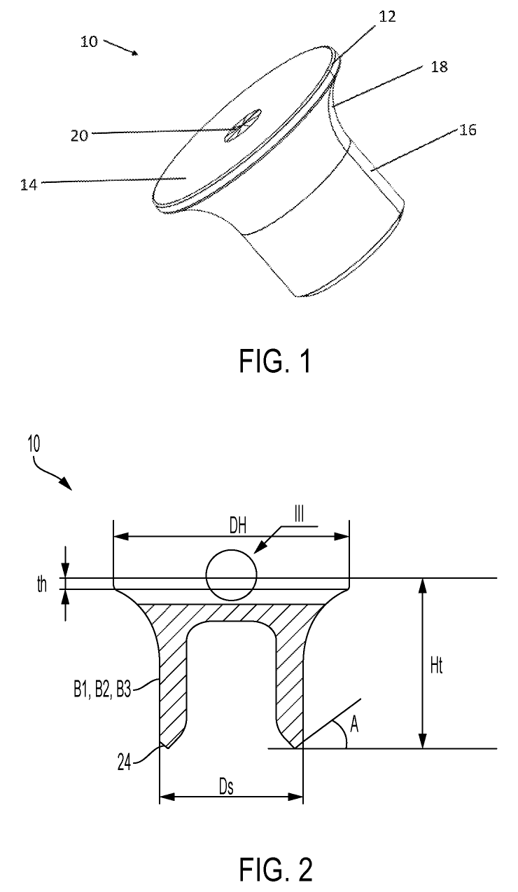

FIGS. 1 and 2 show a self-piercing rivet 10 adapted to join together a workpiece arrangement comprising for instance a first and a second workpiece. FIG. 1 shows more particularly a self-piercing rivet 10.

The self-piercing rivet 10 comprises a head 12. The head 12 comprises a top surface 14. The top surface 14 may for instance be circular and have a head diameter DH. The head diameter DH may be greater than 5 millimeters (mm). For instance, the head diameter DH may be 5.5 mm or 7.75 mm. The head 12 has for instance a cylindrical head outer surface and a head thickness th of for example 1 mm. The head is connected to a shaft 16 through a transition portion 18. The transition portion 18 may have a radius between 1 and 2 mm. The shaft 16 is longitudinally extending along a longitudinal axis from the transition portion 18. The transition portion 18 is arranged opposite the top surface 14.

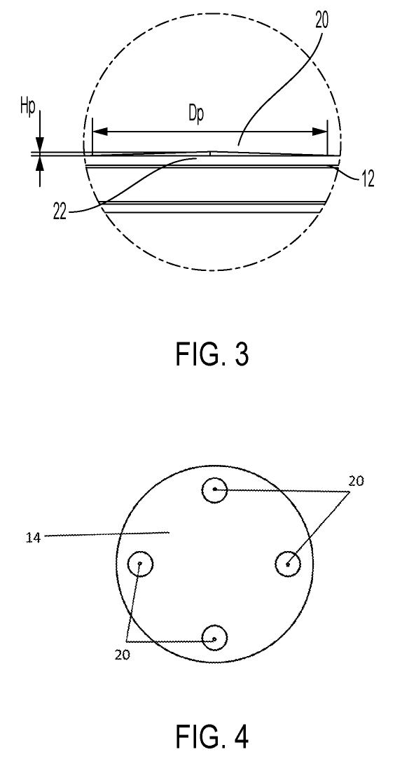

A projection 20 is arranged on the top surface 14. The projection 20 is depicted for instance in FIG. 3. The projection 20 is defined by a shape, which may not offer a planar surface. The projection 20 may for instance be conical. In other embodiments, the projection 20 may be pyramidal or may have a semi-spherical shape. The base 22 of the projection 20 is defined by a portion of the top surface 14. The projection 20 may comprise a projection base diameter Dp (corresponding to the diameter of the base of the projection 20 formed on the top surface 14). The projection base diameter may for instance be between 1/2 and 1/10 of the head diameter DH. More particularly, a ratio of the projection base diameter Dp to the head diameter DH may be between 0.1 and 0.3 mm. The projection 20 defines a projection height Hp. For instance, for a head diameter DH of 5.5 mm, the projection base diameter Dp may be between 0.9 and 1.3 mm and the projection height Hp may be between 0.02 and 0.04 mm. For a self-piercing rivet with a head diameter DH of 7.75 mm, the projection base diameter Dp may be between 1.2 and 1.6 mm and the projection height Hp may be between 0.02 and 0.04 mm. More generally, the projection height Hp may be between 1/500 and 1/50 of the rivet head diameter DH.

More generally, the self-piercing rivet 10 may have more than one projection 20.

FIG. 4 schematically shows the top surface of a rivet 10 with four projections 20. The projections 20 are for instance identical. In other embodiments, the projections may be different. As depicted in FIG. 4, the four projections are regularly distributed on the top surface 14. More particularly, the self-piercing rivet 10 may have a plurality of projections 20 and the projections 20 are arranged on the top surface 14 in such a way that a tilting of the rivet 10 during the setting step is avoid. For instance, the plurality of projections 20 are regularly or evenly distributed over the top surface 14 or the plurality of projections 20 are arranged in a manner that a balance is created on the top surface 14, avoiding tilting during the setting step.

The self-piercing rivet 10 is made integrally (e.g., as a single piece) from a metal material. The rivet 10 is preferably from a unitary metal material, particularly steel. The self-piercing rivet 10 is for instance made of 37MnB4. The self-piercing rivet may have a hardness in a range from 220 ± 30 HV10 to 590 ± 30 HV10, particularly in a range from 380 ± 30 HV10 to 510 ± 30 HV10, measured as a Vickers hardness. The hardness may be in a range from below H0 to H6.

The self-piercing rivet 10 defines a rivet height or rivet length Ht. For instance the rivet length Ht is defined between the rivet foot end and the top surface 14. The projection height Hp is for instance between 1/500 and 1/100 of the rivet height Ht.

As depicted in the figures, the shaft 16 may be a hollow or semi-hollow shaft open at a first end and having a shaft internal diameter and a shaft external diameter Ds. The shaft 16 may have an outer diameter between 3 and 6 mm. The internal diameter of the shaft 16 is smaller than the external diameter Ds. The shaft 16 may comprise at the first end an annular cutting edge 24 defining a cutting-edge diameter smaller than the shaft external diameter Ds. The shaft internal diameter merges with the annular cutting edge via a cutting-edge radius. The annular cutting-edge 24 may merge with the shaft external diameter Ds via a shaft outer chamfer which is oriented at a chamfer angle A. The chamfer angle A is for instance of less than 45 degrees. In other embodiments, other rivet shapes and more particularly self-piercing rivet shapes may be provided.

If the self-piercing rivet 10 is driven into a workpiece arrangement formed by stacked components, it pierces with its annular cutting edge into the upper component and, during the further joining process, the shaft fully penetrates the upper component. When the shaft enters the lower component, the lower surface of the lower component comes into contact with the bottom of the die, so as to create a reaction force. As a result, the hollow shaft of the rivet opens in a ring shape in the lower component without penetrating the lower component.

The self-piercing rivet 10 comprises a three-layer coating or three coating layers B1, B2, B3 adapted to prevent corrosion and better control the friction.

The first coating layer B1 is for instance an electroplated coating layer. In other words, the first coating layer B1 is provided on the rivet body by means of electrolysis. The first coating layer B1 may be a corrosion protection layer. For example, the first coating layer B1 is a zinc nickel layer. In other embodiment, the first coating layer B1 may be a zinc-based coating or a nickel-based coating or a copper-based coating. For example, the first coating layer B1 is made of at least one material which is selected from the group which comprises: Zn, a Zn alloy, ZnNi, Ni, a Ni alloy, NiP, NiW, Cu, a Cu alloy, CuNi, etc. The first coating layer may have a thickness in a range from 3 micrometers (µm) to 12 µm, particularly in a range from 5 µm to 10 µm.

The second coating layer B2 is a passivation layer. The second coating layer B2 is provided on top of the first coating layer B1 by a passivation process. The passivation layer forms a non-metallic layer, for instance a non-metallic conversion layer. The passivation layer is for example a nickel-free inorganic conversion layer. The passivation layer provided on top of the base coating by a passivation process has a thickness which is preferably in a range from 50 nanometers (nm) to 400 nm. The passivation process is preferably a chemical process for reducing the reactivity of this layer and for delaying white rust formation or corrosion of the base coating.

The third coating layer B3 is a friction control layer or a top coat layer. The third coating layer B3 is arranged on top of the passivation layer. The third layer controls the friction value, but also improves corrosion resistance, chemical resistance against acids, and acts as another isolation layer. The third coating layer is for instance applied via a dip-spin process. For instance, the self-piercing rivet with the first and second coating layers is placed in a meshed basket. The mesh basket is then submerged into the coating solution. In a subsequent step, the mesh basket is removed from the coating solution and spun to remove any coating solution excess on the self-piercing rivet. A plurality of rivets is coated during the dip-spin process. Notably, the projection allows, during the dip-spin process, the self-piercing rivets to avoid sticking with each other, and notably avoids two different self-piercing rivets sticking to each other, which would for instance prevent a correct coating of the rivet surfaces. The third coating layer has friction control properties. It might be a lubricant only to ensure a correct friction behavior and electrical conductivity. The third coating layer B3 can also for instance be nickel-free. The third coating layer B3 is an organic coating, particularly an organic coating containing aluminum. Particularly, it is preferred if the third coating layer B3 is made of at least one material which is selected from the group which comprises: Magni B18, Torque’N’Tension, Microgleit DF 921, etc. Magni B18 is a well-known top coat. The same applies to the other above-listed coating materials of other manufacturers. The third coating layer B3 has for example a friction coefficient in a range from 0.07 to 0.19, particularly in a range from 0.08 to 0.18, preferably in a range from 0.12 to 0.18 or in a range from 0.08 to 0.13. The third coating layer B3 may have a thickness in a range from 1 µm to 6 µm, particularly in a range from 2 µm to 4 µm.

The coating is provided preferably on the entire surface of the self-piercing rivet 10, although it is generally possible to provide the coating only in certain areas of the surface. Particularly, it is preferred if at least the outer circumference of the shaft 16 and the head top surface 14 are coated, because the friction coefficient is of particular relevance in the area of the shaft of the self-piercing rivet, and because the head top surface 14 needs to be coated in order to provide the necessary corrosion resistance. Preferably, the head underside radius 18 and/or the annular cutting edge 24 of the shaft 16 and/or the annular radial end surface of the shaft 16 are coated as well.

The coating having a sticky finish, the projection 20 prevents risks of adhesion or sticking between multiple ones of the self-piercing rivet 10. The projection 20 is easily manufactured during the manufacturing process of the rivet. Its shape and geometry do not influence the joining performance of the self-piercing rivet, but sensibly increase its handling, storage and its use in automated processes. More particularly, the at least one projection 20, on the top surface 14, prevents the presence of a large planar surface more prone to sticking.

self-piercing rivet 10
head 12
top surface 14
head diameter DH
head thickness th
shaft 16
transition portion 18
projection 20
base 22
projection base diameter Dp
projection height Hp
rivet height or rivet length Ht
shaft external diameter Ds
annular cutting edge 24
chamfer angle A
three coating layers B1, B2, B3

1. A self-piercing rivet comprising:
a head with a top surface;
a hollow shaft longitudinally extending along a longitudinal axis; and
a transition portion between the shaft and the head,
wherein the rivet is integrally made from a metal material and includes a coating adapted to prevent corrosion of the rivet, and wherein at least one projection is arranged on the top surface of the head.

2. The self-piercing rivet according to claim 1, wherein the coating is a three-layer coating, and wherein an outer circumference of the shaft and the head top surface are coated with the three-layers coating.

3. The self-piercing rivet according to claim 2, wherein the three-layer coating includes an electroplated coating layer, a passivation layer and a top coat layer.

4. The self-piercing rivet according to claim 3, wherein the electroplated coating layer is a zinc nickel layer.

5. The self-piercing rivet according to claim 4, wherein the zinc nickel layer includes a nickel content between 8 and 20%, preferably 12% to 16%.

6. The self-piercing rivet according to claim 2, wherein the three-layer coating includes a top coat layer, and wherein the top coat layer is an organic coating containing aluminum.

7. The self-piercing rivet according to claim 6, wherein the top coat layer is applied via a dip-spin process.

8. The self-piercing rivet according to claim 6, wherein the top coat layer is a friction control coating layer and has a friction coefficient in a range from 0.01 to 0.19, particularly in a range from 0.08 to 0.18, and preferably in a range from 0.12 to 0.18 or in range from 0.08 to 0.13.

9. The self-piercing rivet according to claim 1, wherein the projection has a projection height Hp, wherein the rivet has a head diameter DH, and wherein the projection height Hp is between 1/500 and 1/50 of the rivet head diameter DH.

10. The self-piercing rivet according to claim 1, wherein the at least one projection includes a plurality of projections which are regularly distributed over the top surface.

11. A method for joining components comprising the following steps:
providing the self-piercing rivet according to claim 1 ;
providing a workpiece arrangement with the components; and
automatically setting the rivet within the workpiece arrangement,
wherein the rivet is deformed during the setting step.

12. The method according to claim 11, wherein the at least one projection is plastically deformed during the setting step.

13. The method according to claim 11, wherein the at least one projection extends beyond a plane of the top surface of the head before the setting step, and the at least one projection lies within the plane after the setting step.

14. The self-piercing rivet according to claim 1 wherein the at least one projection is configured to be plastically deformed when the rivet is driven into a workpiece.

15. The self-piercing rivet according to claim 1 wherein the at least one projection has one of a conical shape, a pyramidal shape, and a semi-spherical shape.
